(19) United States
(12) Patent Application Publication
(10) Pub. No.: US 2019/0129594 A1
(43) Pub. Date: May 2, 2019

(54) DISPLAY PROCESSING APPARATUS, NON-TRANSITORY COMPUTER READABLE MEDIUM, AND DISPLAY DEVICE DRIVING METHOD

(71) Applicant: FUJI XEROX CO., LTD., Tokyo (JP)

(72) Inventor: Yusuke TAMURA, Kanagawa (JP)

(73) Assignee: FUJI XEROX CO., LTD., Tokyo (JP)

(21) Appl. No.: 16/159,099

(22) Filed: Oct. 12, 2018

(30) Foreign Application Priority Data
Oct. 26, 2017 (JP) 2017-206758

(51) Int. Cl. G06F 3/0484; G06F 17/30; G06F 3/0481

(52) U.S. Cl. CPC G06F 3/0484; G06F 17/30221; G06F 3/0481; G06F 17/30991; G06F 17/30961

(57) ABSTRACT

A display processing apparatus includes a receiving unit and a restricting unit. The receiving unit receives designation of a target node among multiple nodes having a hierarchical tree structure. The restricting unit restricts a tree view of the multiple nodes, depending on the number of levels from a start point of the levels to the target node.

### CROSS-REFERENCE TO RELATED APPLICATIONS

This application is based on and claims priority under 35 USC 119 from Japanese Patent Application No. 2017-206758 filed Oct. 26, 2017.

### BACKGROUND

### (i) Technical Field

The present invention relates to a display processing apparatus, a non-transitory computer readable medium, and a display device driving method.

### (ii) Related Art

Tree views having multiple nodes in a hierarchical structure displayed in a tree form occasionally have a large number of sibling nodes having the same parent node and located in a level lower than the level of the parent node or have a large number of levels including nodes having parent-child relationships.

### SUMMARY

According to an aspect of the invention, there is provided a display processing apparatus including a receiving unit and a restricting unit. The receiving unit receives designation of a target node among multiple nodes having a hierarchical tree structure. The restricting unit restricts a tree view of the multiple nodes, depending on the number of levels from a start point of the levels to the target node.

### BRIEF DESCRIPTION OF THE DRAWINGS

An exemplary embodiment of the present invention will be described in detail based on the following figures, wherein:

FIG. 1 is a diagram illustrating a specific example of a display processing apparatus favorable for the exemplary embodiment;

FIG. 2 is a diagram illustrating a specific example of multiple nodes in a hierarchical structure;

FIG. 3 is a diagram illustrating a specific example of a displayed image including a tree view;

FIGS. 4A and 4B are diagrams respectively illustrating specific examples of restricted tree views;

FIGS. 5A and 5B are diagrams respectively illustrating specific examples of a collective tree view and a step-by-step tree view;

FIG. 6 is a flowchart illustrating a specific example of a display restriction process executed by the display processing apparatus in FIG. 1; and

FIG. 7 is a flowchart illustrating a specific example of a display restriction cancellation process executed by the display processing apparatus in FIG. 1.

### DETAILED DESCRIPTION

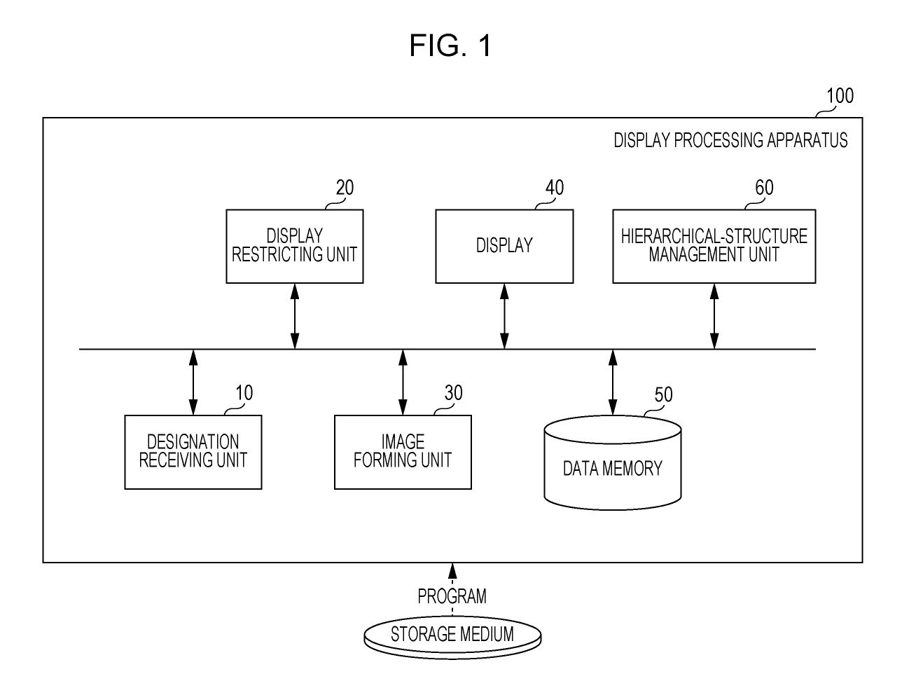

FIG. 1 is a diagram illustrating a specific example of a display processing apparatus favorable for an exemplary embodiment of the present invention. In the specific example illustrated in FIG. 1, a display processing apparatus 100 includes a designation receiving unit 10, a display restricting unit 20, an image forming unit 30, a display 40, a data memory 50, and a hierarchical-structure management unit 60.

The designation receiving unit 10 receives designation input in response to a user operation performed by using an operation device or the like. The designation receiving unit 10 receives designation of a target node among multiple nodes having, for example, a hierarchical tree structure.

The display restricting unit 20 restricts a tree view formed by the image forming unit 30. The display restricting unit 20 restricts the tree view of the multiple nodes, depending on the number of levels, for example, from the start point of the levels to the target node.

The image forming unit 30 forms a displayed image to be displayed on the display 40. The image forming unit 30 forms the displayed image including, for example, a tree view displaying multiple nodes having the hierarchical tree structure.

The display 40 displays the displayed image formed by the image forming unit 30. A favorable specific example of the display 40 is a display device such as a display. Note that the display processing apparatus 100 does not necessarily have to include the display 40. For example, if the display processing apparatus 100 does not include the display 40, the displayed image formed by the image forming unit 30 may be displayed on a display device or the like connected as an external device to the display processing apparatus 100.

The data memory 50 stores therein multiple pieces of data having a hierarchical structure. A favorable specific example of the data memory 50 is a memory device such as a memory or a hard disk. The data memory 50 stores therein files including various pieces of data represented by, for example, document data and image data.

The hierarchical-structure management unit 60 manages the hierarchical structure related to the pieces of data stored in the data memory 50. The hierarchical-structure management unit 60 manages, for example, files stored in the data memory 50 by using a hierarchical structure having folders as nodes.

The display processing apparatus 100 may be implemented by using, for example, a computer. The computer has hardware resources that are a computing device such as a CPU, a memory device such as a memory or a hard disk, a communication device using a communication network such as the Internet, a device that reads and writes data from and to a storage medium such as an optical disk or a semiconductor memory, a display device such as a display, an operation device that receives a user operation from a user, and the like.

The computer reads a program (software) for, for example, at least one of functions denoted by reference numerals included in the display processing apparatus 100 illustrated in FIG. 1 and implements the at least one of the functions of the display processing apparatus 100 in such a manner that the hardware resources of the computer and the read software cooperate with each other. The program may be provided to the computer (display processing apparatus 100) through the communication network such as the Internet or in such a manner as to be stored in a storage medium such as an optical disk.

The overall configuration of the display processing apparatus 100 illustrated in FIG. 1 has heretofore been described. Next, the functions and the like implemented by the display processing apparatus 100 in FIG. 1 will be described in detail. In the following description, the reference numerals in FIG. 1 are used for the configuration (components) illustrated in FIG. 1.

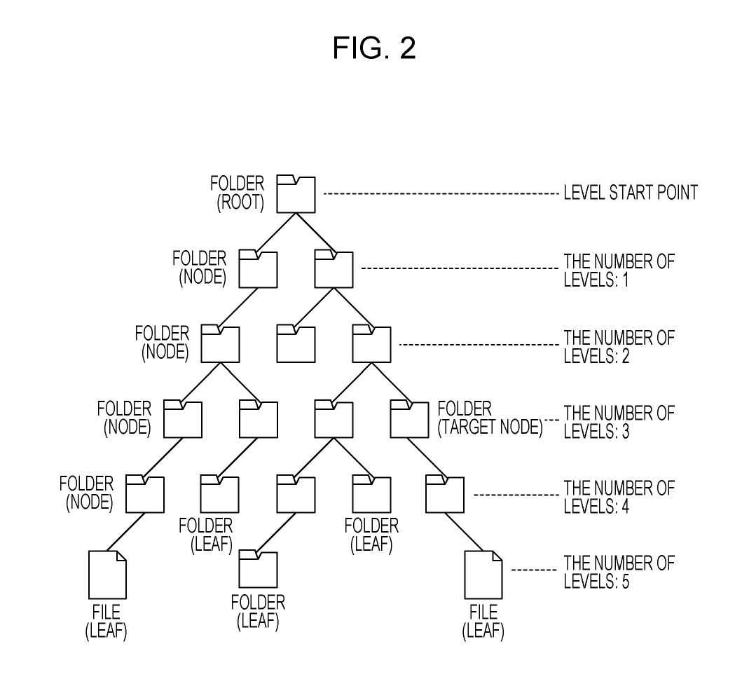

FIG. 2 is a diagram illustrating a specific example of multiple nodes in a hierarchical structure. FIG. 2 illustrates the specific example of the hierarchical structure having folders as nodes. Specifically, FIG. 2 illustrates the hierarchical structure having parent-child relationships in which a folder or a file serving as a child is present in a folder serving as a parent (in a lower level than the level of the folder serving as the parent).

Among the multiple nodes in the hierarchical structure, a node in the highest level is called a root, and a node in the lowest level (end) is called a leaf. There is also a case where multiple folders (or files) are present in the folder serving as the parent. The multiple folders or the files having the same parent folder have a sibling relationship.

In the specific example illustrated in FIG. 2, for example, if a folder that is the root in the highest level is the start point of the levels, the number of levels from the start point to a folder that is a target node is 3.

The hierarchical-structure management unit 60 manages the files stored in the data memory 50 by using the hierarchical structure having folders as nodes, for example, as illustrated in FIG. 2. The image forming unit 30 forms a displayed image including, for example, a tree view displaying, in a tree form, the multiple nodes in the hierarchical structure.

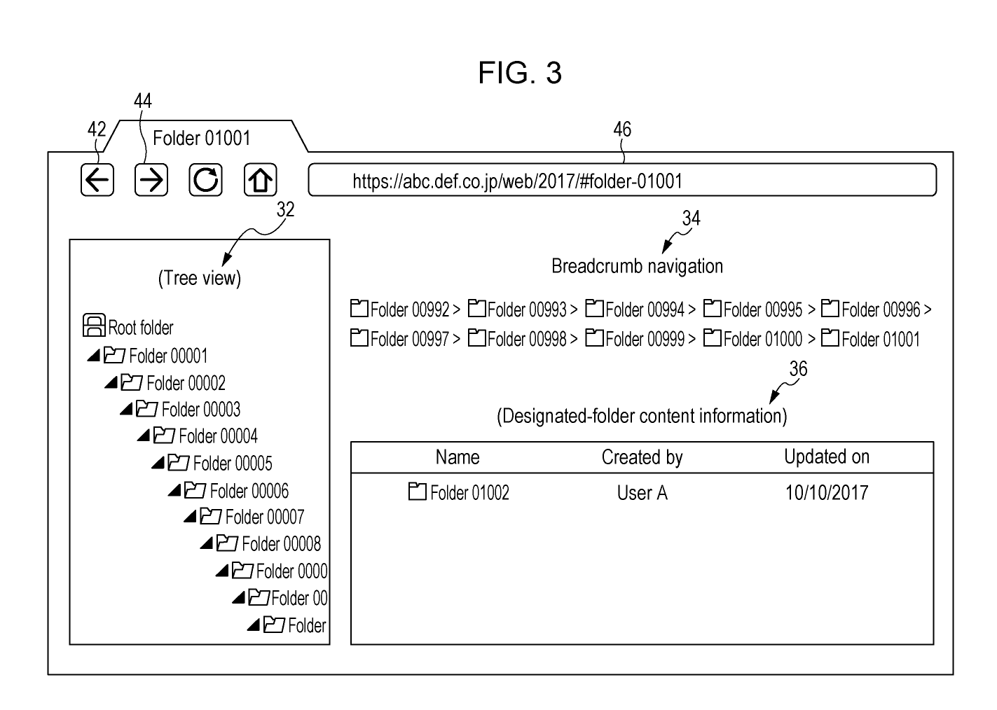

FIG. 3 is a diagram illustrating a specific example of a displayed image including a tree view. FIG. 3 illustrates the specific example of the displayed image formed by the image forming unit 30 and displayed on the display 40. The displayed image in FIG. 3 is displayed by a viewer such as a browser. In the specific example illustrated in FIG. 3, the displayed image includes a tree view 32, breadcrumb navigation 34, and designated-folder content information 36.

The tree view 32 is an image in which the hierarchical structure of folders including a designated folder that is designated as a target node is illustrated in the tree form. For example, parent-child relationships observed from the folder serving as the root of the hierarchical structure to the designated folder are illustrated in the tree form.

The specific example illustrated in FIG. 3 has a folder 01001 that is the designated folder and displays a tree image in which the parent-child relationships observed downwards from the folder serving as the root of the hierarchical structure to the designated folder are illustrated in the tree form.

Note that if the display area of the tree view 32 is not sufficiently large to display the whole tree image from the root folder to the folder 01001, only part of the tree image may be displayed in the display area, for example, as illustrated in the specific example of the tree view 32 in FIG. 3, and the displayed part may be changed in response to a scroll operation performed by the user.

The breadcrumb navigation 34 is an image representing part of a path to the designated folder in the hierarchical structure. For example, a list of the designated folder and multiple folders in upper levels (in a direction to a parent) than the level of the designated folder is displayed in levels the number of which is set.

In the specific example illustrated in FIG. 3, the set number of levels is 10, and part of a path to the folder 01001 that is the designated folder is illustrated by using ten folders having the parent-child relationships from the folder 01001 that is the designated folder to a folder 00992.

The designated-folder content information 36 is information regarding the designated folder. For example, a folder designated by the user is the designated folder, and a folder or a file in the designated folder is displayed as the designated-folder content information 36.

In the specific example illustrated in FIG. 3, the folder 01001 is the designated folder, and a name, a user who created the folder, and an update date regarding a folder 01002 (a child of the folder 01001) in the folder 01001 are displayed. If the designated folder contains multiple folders (files), information regarding the multiple folders (files) in a sibling relationship may be displayed as the designated-folder content information 36.

In the specific example illustrated in FIG. 3, for example, when the user operates a Back button 42 in the displayed image, the displayed image thereby returns to a displayed image of a designated folder that is designated immediately before the current designated folder (the folder 01001 in the example in FIG. 3). For example, when the user operates a Next button 44 in the displayed image, the displayed image thereby proceeds to a displayed image of a designated folder that is designated immediately after the current designated folder.

Further, in the specific example illustrated in FIG. 3, when a path to a folder that is the target node (for example, a uniform resource locator (URL)) is input in an entry field 46, the folder is thereby designated as the designated folder. Clicking on the image of a folder displayed in the displayed image may serve as designating the folder as the designated folder.

The displayed image formed by the image forming unit 30 is restricted by the display restricting unit 20. The display restricting unit 20 restricts the tree view 32 of the multiple nodes, depending on the number of levels from, for example, the start point of the levels to the target node.

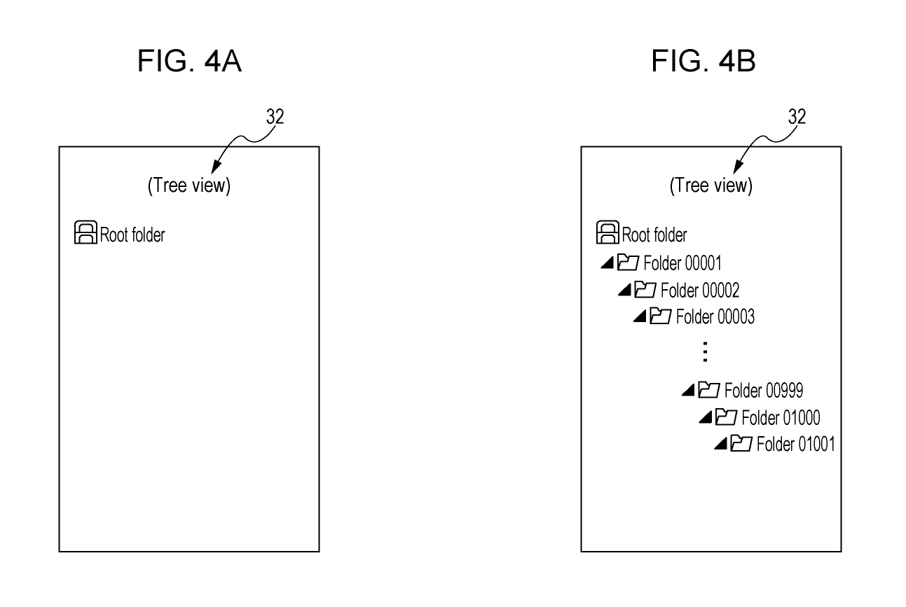

FIGS. 4A and 4B are diagrams respectively illustrating specific examples of restricted tree views. For example, if the number of levels up to a designated folder (designated node) designated as a target node exceeds a restriction value, the display restricting unit 20 restricts the tree view 32. The display restricting unit 20 restricts the tree view 32, for example, such that at least one of multiple nodes is omitted in displaying.

For example, suppose a case where the restriction value of the number of levels is 1000. If the folder 01001 in the 1001-th level from the root folder is designated as the target node, the tree view 32 is restricted as in the specific example illustrated in FIG. 4A or 4B.

A specific example 1 in FIG. 4A illustrates the tree view 32 restricted only to the root folder that is the root node. Specifically, the tree view 32 in which the root folder is left in the hierarchical structure from the root folder to the folder 01001 and the other folders are omitted is the specific example 1.

In the specific example 1, only the root folder may be used to form the tree view 32, and thus workload on image processing for forming the tree view 32 is reduced compared with a case where all of folders, for example, from the root folder to the folder 01001 are used to form the tree view 32.

In contrast, a specific example 2 in FIG. 4B illustrates the tree view 32 in which only part of the hierarchical structure from the root folder to the folder 01001 is left and the other folders are omitted. Specifically, the tree view 32 in which a partial hierarchical structure from the root folder to a folder 00003 near the root folder and a partial hierarchical structure from a folder 00999 near the folder 01001 to the folder 01001 are left and folders from a folder 00004 to a folder 00998 are omitted is the specific example 2.

Also in the specific example 2, workload on image processing for forming the tree view 32 is reduced compared with the case where all of the folders, for example, from the root folder to the folder 01001 are used to form the tree view 32.

Although the specific examples in which the restriction value of the number of levels is 1000 have been described with reference to FIGS. 4A and 4B, the restriction value of the number of levels is not limited to that in the specific examples in FIGS. 4A and 4B. For example, the restriction value of the number of levels may be set by the user.

In a collective tree view in which multiple nodes are displayed collectively, the display restricting unit 20 restricts the tree view 32, depending on the number of levels. In a step-by-step tree view in which multiple nodes are displayed step by step, the display restricting unit 20 does not restrict the tree view 32, regardless of the number of levels.

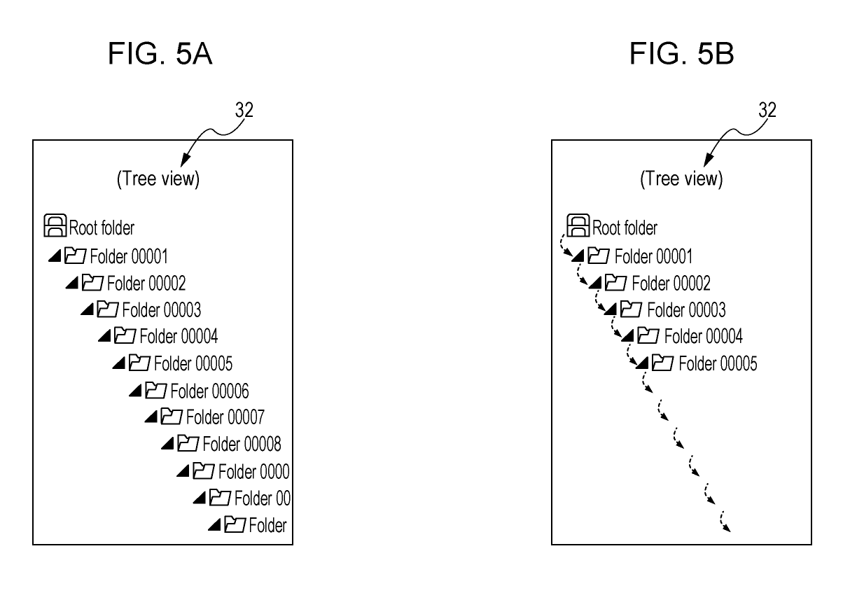

FIGS. 5A and 5B are diagrams respectively illustrating specific examples of the collective tree view and the step-by-step tree view. In the collective tree view in FIG. 5A, the image forming unit 30 performs image processing at a time (for example, simultaneously) on multiple nodes constituting a tree and forms an image of the whole tree.

In the collective tree view, for example, immediately after the designated folder is designated, the image processing is performed on all of the folders from the root folder to the designated folder, and the image of the whole tree representing the hierarchical structure of all of the folders from the root folder to the designated folder is formed.

As described above, the image processing is performed on the multiple folders at a time in the collective tree view. Accordingly, if a huge number of folders are processed, the image processing load is extremely increased in a moment. Hence, the display restricting unit 20 restricts the tree view 32, depending on the number of levels. If the number of levels, for example, from the root folder to the designated folder (designated node) exceeds the restriction value, the display restricting unit 20 restricts the tree view 32. For example, as in the specific examples 1 and 2 respectively illustrated in FIGS. 4A and 4B, the tree view 32 is restricted. The load on the image processing for forming the tree view 32 is thereby reduced compared with the case where the tree view 32 is not restricted.

Although the image of the whole tree is formed at a time in the collective tree view, only part of the image of the whole tree may be displayed, for example, as in the collective tree view illustrated in the specific example in FIG. 5A. In the case where only part of the tree image is displayed in the display area, the displayed part may be configured to be changed in response to a scroll operation performed by the user.

In contrast, in the step-by-step tree view in FIG. 5B, the image forming unit 30 performs the image processing step by step on the multiple nodes constituting the tree and forms an image of the tree view 32 step by step. In the step-by-step tree view, for example, every time the user performs an operation for designating (developing) a folder, the multiple folders are developed serially from the root folder, and an image of the tree view 32 representing the hierarchical structure up to the designated folder is formed.

As described above, the image processing is performed on the folders one by one in the step-by-step tree view. The image processing load is thus temporally distributed, and the image processing load is not extremely increased in a moment. Hence, in the step-by-step tree view, the display restricting unit 20 does not restrict the tree view 32, regardless of the number of levels.

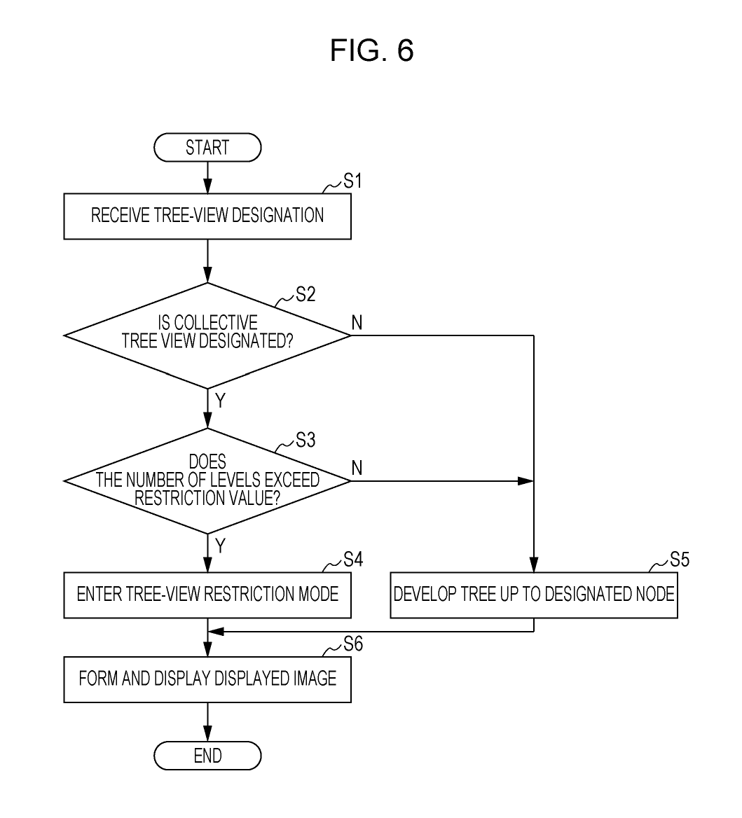

FIG. 6 is a flowchart illustrating a specific example of a display restriction process executed by the display processing apparatus 100 in FIG. 1. First, if the designation of a tree view is received (S1), it is verified whether the received designation is the designation of the collective tree view (S2).

For example, if an operation for designating a link to a target node is performed, it is judged that the collective tree view is designated. For example, if a link to a designated folder that is the target node is designated by inputting a path to a folder (for example, a URL is input in the entry field 46 in FIG. 3), it is judged that the collective tree view is designated.

For example, if a designated folder is selected by clicking on the image of the folder displayed in the displayed image (see FIG. 3) (except an operation for developing the folder step by step), it is also judged that the collective tree view is designated.

For example, if the designated folder is changed through an operation for changing the display content of the displayed image to that of the previous image or next image (for example, operating the Back button 42 or the Next button 44 on the display screen in FIG. 3), it may be judged that the collective tree view is designated.

If it is judged that the collective tree view is designated (S2), it is judged whether the number of levels up to the designated folder (designated node) designated as the target node exceeds the restriction value (S3). If the number of levels exceeds the restriction value, the display state is changed to mode for restricting the tree view (S4), and a displayed image is formed and displayed with the tree view being restricted (see FIG. 4) (S6).

In contrast, if the number of levels does not exceed the restriction value (S3), the tree view is not restricted, the tree is developed up to the designated folder (designated node) (S5), and a displayed image is formed and displayed with the tree view being not restricted (S6).

Referring back to S2, if the received designation is not the designation of the collective tree view, for example, if an operation for developing the folder step by step is performed, the tree is developed step by step up to the designated folder (designated node) (S5), and the displayed image is formed and displayed with the tree view being not restricted (S6).

It is desirable that the display restricting unit 20 not restrict the tree view of the multiple nodes in response to a change of the display area for the tree view. For example, suppose a case where the image of the tree view illustrated in FIG. 3 is formed with the tree view being not restricted. In this case, even if the size (area) of the display area for the tree view is changed in response to a user operation or the like, only part of the image of the whole tree is displayed with the tree view being not restricted. In the case where only part of the tree image is displayed in the display area, the displayed part may be configured to be changed in response to a scroll operation or the like by the user.

If a new target node is designated in the state where the tree view is restricted (tree-view restriction mode), and if the number of levels from the start point of the levels to the new target node does not exceed the restriction value, the display restricting unit 20 transitions from the state where the tree view is restricted to a state where the tree view is not restricted.

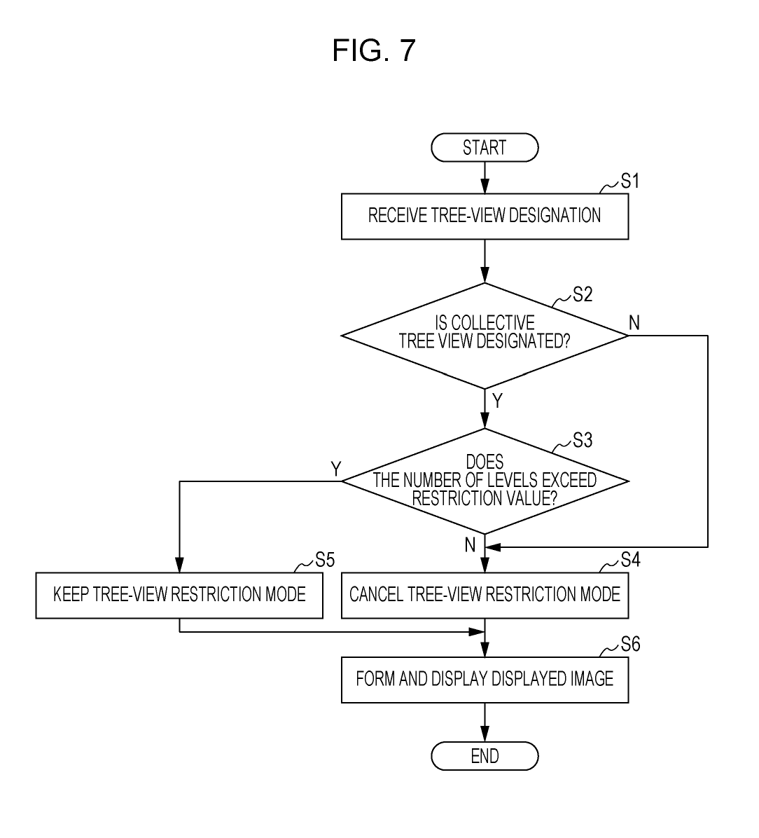

FIG. 7 is a flowchart illustrating a specific example of a display restriction cancellation process executed by the display processing apparatus 100 in FIG. 1. At the start of the flowchart illustrated in FIG. 7, the display state is the state where the tree view is restricted (tree-view restriction mode).

First, if the designation of the tree view is received (S1), it is verified whether the received designation is the designation of the collective tree view (S2). For example, in a case or the like where an operation for designating a link to the target node is performed, it is judged that the collective tree view is designated (see S2 in FIG. 6).

If it is judged that the collective tree view is designated (S2), it is judged whether the number of levels up to the designated folder (designated node) designated as the target node exceeds the restriction value (S3).

If the number of levels does not exceed the restriction value (S3), the tree-view restriction mode is cancelled (S4), the tree is developed up to the designated folder (designated node), and the displayed image is formed and displayed with the tree view being not restricted (S6). In contrast, if the number of levels exceeds the restriction value (S3), the tree-view restriction mode is kept (S5), and the displayed image is formed and displayed with the tree view being restricted (S6).

Referring back to S2, if the received designation is not the designation of the collective tree view, for example, if an operation for developing the folder step by step is performed, the tree-view restriction mode is cancelled (S4), the tree is developed step by step up to the designated folder (designated node), and the displayed image is formed and displayed with the tree view being not restricted (S6).

The favorable exemplary embodiment has heretofore been described, but the above-described exemplary embodiment is merely an example in every respect and does not limit the scope of the present invention. The exemplary embodiment includes various modes of modification without departing from the spirit of the invention.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display processing apparatus comprising:
a receiving unit that receives designation of a target node among a plurality of nodes having a hierarchical tree structure; and
a restricting unit that restricts a tree view of the plurality of nodes, depending on the number of levels from a start point of the levels to the target node.

2. The display processing apparatus according to claim 1,
wherein if the number of levels up to the target node exceeds a restriction value, the restricting unit restricts the tree view.

3. The display processing apparatus according to claim 1,
wherein if the number of levels up to the target node does not exceed a restriction value, the restricting unit does not restrict the tree view.

4. The display processing apparatus according to claim 2,
wherein if the receiving unit receives designation of a new target node in a state where the tree view is restricted, and if the number of levels from the start point of the levels to the new target node does not exceed the restriction value, the restricting unit transitions from the state where the tree view is restricted to a state where the tree view is not restricted.

5. The display processing apparatus according to claim 1,
wherein in a collective tree view in which the plurality of nodes are collectively displayed, the restricting unit restricts the tree view, depending on the number of levels.

6. The display processing apparatus according to claim 1,
wherein in a step-by-step tree view in which the plurality of nodes are displayed step by step, the restricting unit does not restrict the tree view, regardless of the number of levels.

7. The display processing apparatus according to claim 6,
wherein the step-by-step tree view is a tree view in which the plurality of nodes are developed and displayed level by level.

8. The display processing apparatus according to claim 1,
wherein the restricting unit restricts the tree view such that at least one of the plurality of nodes is omitted in displaying.

9. The display processing apparatus according to claim 1,
wherein if the designation of the target node received by the receiving unit corresponds to designation of a collective tree view in which the plurality of nodes are collectively displayed, the restricting unit restricts the tree view, depending on the number of levels up to the target node.

10. The display processing apparatus according to claim 9,
wherein an operation for designating a link to the target node serves as the designation of the collective tree view.

11. The display processing apparatus according to claim 1,
wherein if the designation of the target node received by the receiving unit corresponds to designation of a step-by-step tree view in which the plurality of nodes are displayed step by step, the restricting unit does not restrict the tree view, regardless of the number of levels up to the target node.

12. The display processing apparatus according to claim 1,
wherein the restricting unit does not restrict the tree view of the plurality of nodes in response to a change of a display area in which the tree view is displayed.

13. A non-transitory computer readable medium storing a program causing a computer to execute a process for display processing, the process comprising:
receiving designation of a target node among a plurality of nodes having a hierarchical tree structure; and
restricting a tree view of the plurality of nodes, depending on the number of levels from a start point of the levels to the target node.

14. A display device driving method comprising:
receiving designation of a target node among a plurality of nodes having a hierarchical tree structure; and
restricting a tree view of the plurality of nodes, depending on the number of levels from a start point of the levels to the target node.
